(19) United States
(12) Patent Application Publication
(10) Pub. No.: US 2022/0076016 A1
(43) Pub. Date: Mar. 10, 2022

(54) REAL-TIME POWER PLANT OPERATIONAL DATA FOR AUGMENTED REALITY ASSISTANCE

(71) Applicant: General Electric Company, Schenectady, NY (US)

(72) Inventors: Manas Ranjan Sahoo, Hyderabad (IN); Swaminathan Rajavelu, Hyderabad (IN); Giridhar Muralidhar Ghatigar, Hyderabad (IN); Venkatesh J, Hyderabad (IN); Sreedhar Babu Manchikatla, Hyderabad (IN); Santanu Rahaman Mondal, Hyderabad (IN)

(21) Appl. No.: 17/014,242

(22) Filed: Sep. 8, 2020

(51) Int. Cl. G06K 9/00; G06T 19/00

(52) U.S. Cl. CPC G06K 9/00671; G06T 19/006

(57) ABSTRACT

A power plant control system includes a memory; and a processor coupled to the memory and configured to process events in the processor according to a method. The system identifies an adjustable component of a power plant based on an image of at least a portion of the adjustable component, the adjustable component controlling at least one operational parameter of the power plant. An operational instruction is generated for the adjustable component from a database based on the image, the operational instruction capable of being rendered visually in an augmented reality (AR) system. The operational instruction is transmitted to the AR system for implementing by a user; and real-time operational data is transmitted to the AR system. The real-time operational data including a change to the at least one operational parameter based on an adjustment made to the adjustable component.

### TECHNICAL FIELD

The disclosure relates generally to power plant control systems, and more particularly, to a system, method and program product that provide real-time power plant operational data for augmented reality assistance relative to an adjustable component of the power plant.

### BACKGROUND

Power plants include a wide variety of adjustable components for controlling operation of the power plant. The power plant is controlled by a control system that operates a large number of adjustable components to control the main sections of the power plant such as but not limited to gas and/or steam turbines and related systems such as compressors, heat recovery steam generators (HRSG), electric power generators, and combustors. The adjustable components can vary widely depending on the power plant main section to be controlled. For example, an adjustable component may include any of a number of valves that control, for example, fuel flow to a combustor, air intake to a compressor, steam flow to a steam turbine, or combustion gas exhaust delivery to atmosphere and/or an HRSG. In another example, the adjustable component could include a control panel that controls one or more other components. Periodically, adjustable components must be adjusted manually. One challenge with manual adjustment is that the human operator may be inexperienced with the adjustable component's operation and/or may not understand the impact a component adjustment may have on power plant operation. For example, human operators may be inexperienced trainees that require additional training, or they may include emergency responders that need to adjust the component in response to an emergency situation.

Augmented reality (AR) systems position a computer-generated image or data on a user's view of the real world, thus providing a composite view. Thus, AR systems are used to provide additional data to a user to be employed in whatever application they are employed. One shortcoming of current AR systems and power plant control systems is that they do not provide real-time power plant operational data to a user. Consequently, user safety and speed of decision-making still relies on personal experience and/or access to experts.

### BRIEF DESCRIPTION

An aspect of the disclosure provides a power plant control system, comprising: a memory; and a processor coupled to the memory and configured to process events in the processor according to a method that includes: identifying an adjustable component of a power plant based on an image of at least a portion of the adjustable component, the adjustable component controlling at least one operational parameter of the power plant; generating an operational instruction for the adjustable component from a database based on the image, the operational instruction capable of being rendered visually in an augmented reality (AR) system; transmitting the operational instruction to the AR system for implementing by a user; and transmitting real-time operational data to the AR system, the real-time operational data including a change to the at least one operational parameter based on an adjustment made to the adjustable component.

Another aspect of the disclosure provides a computer-implemented method of controlling operation of at least a portion of a power plant, the method comprising: identifying an adjustable component of a power plant based on an image of at least a portion of the adjustable component, the adjustable component controlling at least one operational parameter of the power plant; generating an operational instruction for the adjustable component from a database based on the image, the operational instruction capable of being rendered visually in an augmented reality (AR) system; transmitting the operational instruction to the AR system for implementing by a user; and transmitting real-time operational data to the AR system, the real-time operational data including a change to the at least one operational parameter based on an adjustment made to the adjustable component.

An additional aspect of the disclosure provides a computer program product stored on a computer readable storage medium, which when executed by a power plant control systems, performs a method for controlling operation of at least a portion of the power plant, the method comprising: identifying an adjustable component of a power plant based on an image of at least a portion of the adjustable component, the adjustable component controlling at least one operational parameter of the power plant; generating an operational instruction for the adjustable component from a database based on the image, the operational instruction capable of being rendered visually in an augmented reality (AR) system; transmitting the operational instruction to the AR system for implementing by a user; and transmitting real-time operational data to the AR system, the real-time operational data including a change to the at least one operational parameter based on an adjustment made to the adjustable component.

Another aspect of the disclosure includes a power plant, comprising: at least one section selected from the group including a gas turbine, a steam turbine, a heat recovery steam generator, a combustor and a compressor; a plurality of adjustable components, each adjustable component controlling at least one operational parameter of the at least one section; and a control system configured to control the at least one turbine system, the control system including: a memory; and a processor coupled to the memory and configured to process events in the processor according to a method that includes: identifying a selected adjustable component based on an image of at least a portion of the selected adjustable component, the selected adjustable component controlling at least one operational parameter of the power plant; generating an operational instruction for the selected adjustable component from a database based on the image, the operational instruction capable of being rendered visually in an augmented reality (AR) system; transmitting the operational instruction to the AR system for implementing by a user; and transmitting real-time real-time operational data to the AR system, the real-time operational data including a change to the at least one operational parameter based on an adjustment made to the selected adjustable component.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 is a schematic view of an illustrative power plant in the form of a combined cycle power plant, according to embodiments of the disclosure;

FIG. 2 is block diagram of a power plant control system, according to embodiments of the disclosure;

FIG. 3 is a view field in an augmented reality system for an illustrative adjustable component, according to embodiments of the disclosure; and

FIG. 4 is a flow diagram of an operational methodology for the power plant control system, according to embodiments of the disclosure.

It is noted that the drawings of the disclosure are not necessarily to scale. The drawings are intended to depict only typical aspects of the disclosure and therefore should not be considered as limiting the scope of the disclosure. In the drawings, like numbering represents like elements between the drawings.

### DETAILED DESCRIPTION

As an initial matter, in order to clearly describe the subject matter of the current disclosure, it will become necessary to select certain terminology when referring to and describing relevant machine components within a power plant. To the extent possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

Several descriptive terms may be used regularly herein, as described below. The terms “first”, “second”, and “third” may be used interchangeably to distinguish one component from another and are not intended to signify location or importance of the individual components. The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Where an element or layer is referred to as being “on,” “engaged to,” “connected to” or “coupled to” another element or layer, it may be directly on, engaged to, connected to, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

As indicated above, the disclosure provides a power plant control system including a memory, and a processor coupled to the memory and configured to process events in the processor according to a method. The system identifies an adjustable component of a power plant based on an image of at least a portion of the adjustable component, where the adjustable component controls at least one operational parameter of the power plant. A user can image a portion of a relevant adjustable component, e.g., using any appropriate portable electronic device, such as mobile phone, tablet, wearable, an augmented reality (AR) system, etc. An operational instruction is generated for the adjustable component based on the image, the operational instruction capable of being rendered visually in the AR system. The operational instruction is transmitted to the AR system for implementing by a user. The operational instruction can take a variety of forms such as but not limited to a set of instruction or guides pertaining to the adjustable component displayed, e.g., through a video, a pictorial representation and/or a model presentation (the latter with, e.g., a different scale or other changed features from the actual component to simplify or better communicate the instruction). The operational instruction helps the user to make an informed decision and complete the task regarding the adjustable component. In addition, the control system transmits real-time operational data about the power plant's operation to the AR system to help the user to precisely know, for example, when the desired operation is fulfilled. The real-time operational data may include a change to the at least one operational parameter based on an adjustment made to the adjustable component. The user can take any appropriate action per the operational instruction and operational data. In one non-limiting example, the control system may be used to assist/train operators to allow faster decision making, quicker training, etc. In another example, the control system may also provide information to, for example, emergency responders so better informed and appropriate, remedial action can be taken faster in an emergency situation.

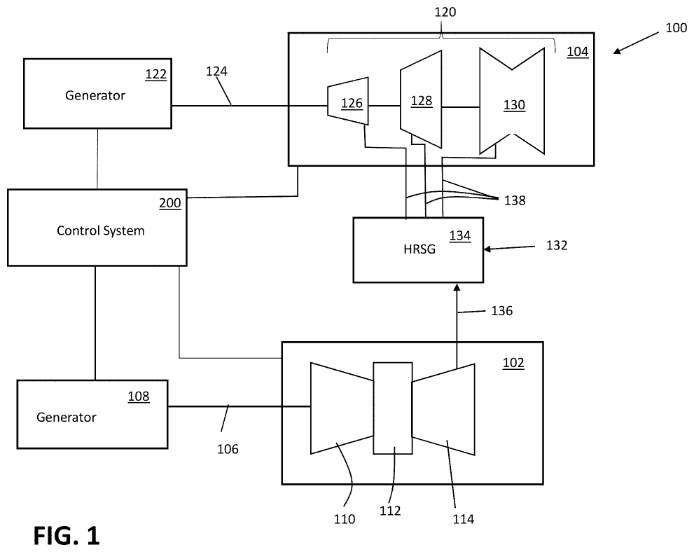

Turning to FIG. 1, a schematic view of portions of an illustrative power plant 100. For purposes of description, power plant 100 includes a combined cycle power plant. Combined cycle power plant 100 may include a number of ‘sections’ including, for example, a gas turbine system 102, a steam turbine system 104, a heat recover steam generator (HRSG) 134, a combustor 112, a compressor 110 and an electric generator(s) 108, 122. It is emphasized that power plant 100 is merely illustrative and the teachings of the disclosure may be applied to any type of power plant.

Gas turbine system 104 may be mechanically coupled by a shaft 106 to a first generator 108, which generates electrical energy. Gas turbine system 102 may include a compressor 110 and a combustor 112. Gas turbine system 102 also includes gas turbine 114 coupled to common compressor/turbine shaft 106. In one embodiment, gas turbine system 102 is a MS7001FB engine, sometimes referred to as a 9FB engine, commercially available from General Electric Company, Greenville, S.C. In one embodiment, GT system 100 is a 7HA.03 engine, commercially available from General Electric Company, Greenville, S.C. The present disclosure is not limited to any one particular GT system and may be implanted in connection with other engines including, for example, the other HA, F, B, LM, GT, TM and E-class engine models of General Electric Company, and engine models of other companies. In operation, air enters the inlet of compressor 110, is compressed and then discharged to combustor 112 where fuel such as a gas, e.g., natural gas, or a fluid, e.g., oil, is burned to provide high energy combustion gases which drive gas turbine 114. In gas turbine 114, the energy of the hot gases is converted into work, some of which is used to drive compressor 110 through rotating shaft 106, with the remainder available for useful work to drive a load such as first generator 108 via shaft 106 for producing electricity.

Steam turbine system 104 includes a steam turbine 120 that is operably coupled to another generator 122 through shaft 124. Steam turbine system 104 may include one or more steam turbines, e.g., as shown, a high pressure (HP) turbine 126, an intermediate pressure (IP) turbine 128 and a low pressure (LP) turbine 130, each of which are coupled to shaft 124. Each steam turbine 126, 128, 130 includes a plurality of rotating blades (not shown) mechanically coupled to shaft 124.

Combined cycle power plant (CCPP) 100 may also include a steam source 132, which may be include, for example, a heat recovery steam generator (HRSG) 134 operably connected to gas turbine system 102 and steam turbine system 104. As understood, exhaust 136 from gas turbine system 102 is used by HRSG 134 to create steam flow(s) 138 for use by steam turbine system 104. HRSG 134 may include a conventional HRSG configuration, such as those used in conventional combined cycle power systems, and/or may be embodied as another type of heat exchanger or similar component for using exhaust energy to produce steam. For example, HRSG 134 may include a thermally conductive pipe, line, etc., with water therein such that water in HRSG 134 is heated by exhaust 136 (FIG. 1) to produce steam flow(s) 138. HRSG 134 may be fluidly connected to both gas turbine system 102 and steam turbine system 104 via conventional piping (numbering omitted), described further herein.

In operation, steam from steam source 132 (e.g., HRSG 134 and perhaps other sources), enters an inlet of HP turbine 126, IP turbine 128 and/or LP turbine 130, and is channeled to impart a force on blades thereof causing shaft 124 to rotate. As understood, steam from an upstream turbine may be employed later in a downstream turbine. The steam thus produced by steam source 132 drives at least a part of steam turbine system 104 in which additional work is extracted to drive shaft 124 and an additional load such as second generator 122 which, in turn, produces additional electric power.

It is understood that generators 108, 122 and shafts 106, 124 may be of any size or type known in the art and may differ depending upon their application or the system to which they are connected. In further implementations (e.g., single shaft arrangements), only one of generators 108, 122 and/or shafts 106, 124 may be operably coupled to gas turbine system 102 and steam turbine system 104. Common numbering of the generators and shafts is for clarity and does not necessarily suggest these generators or shafts are identical.

Power plant 100 also includes a control system 200 operable to control, monitor and/or adjust operation of any desired aspect of power plant 100, e.g., via one or more adjustable components. As used herein, an “adjustable component” can be any part controlling at least one operational parameter of the power plant, and capable of adjustment or adjustable operation by a human operator or user, and a “selected adjustable component” is an adjustable component that is the focus of the methodology. Non-limiting examples may include at least one of: an electronic control panel, a valve, an electric switch and any electro-mechanical devices.

As will be appreciated by one skilled in the art, a power plant control system 200 (hereafter “control system 200”) according to the present disclosure may be embodied as a system, method or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in any tangible medium of expression having computer-usable program code embodied in the medium. Control system 200 described herein may be part of a larger power plant control system, the details and functioning of which are well understood and will not be described herein.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, a magnetic storage device, or a solid state storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

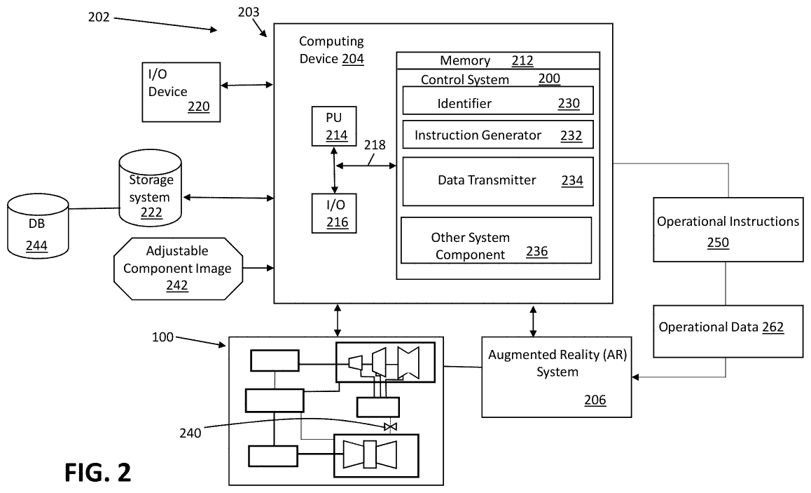

FIG. 2 shows an illustrative environment 202 for control system 200. To this extent, environment 202 includes a computer infrastructure 203 that can perform the various process steps described herein for control system 200. In particular, computer infrastructure 203 is shown including a computing device 204 that comprises control system 200, which enables computing device 204 to provide operational instructions and real-time operational data to an augmented reality (AR) system 206 by performing the process steps of the disclosure.

Computing device 204 is shown including a memory 212, a processor (PU) 214, an input/output (I/O) interface 216, and a bus 218. Further, computing device 204 is shown in communication with an external I/O device/resource 220 and a storage system 222. As is known in the art, in general, processor 214 executes computer program code, such as control system 200, that is stored in memory 212 and/or storage system 222. While executing computer program code, processor 214 can read and/or write data, such as operational data, to/from memory 212, storage system 222, and/or I/O interface 216. Bus 218 provides a communications link between each of the components in computing device 204. I/O device 216 can comprise any device that enables a user to interact with computing device 204 or any device that enables computing device 204 to communicate with one or more other computing devices. Input/output devices including but not limited to keyboards, displays, pointing devices, augmented reality (AR) system 206 (the latter described further herein), etc., can be coupled to the system either directly or through intervening I/O controllers.

In any event, computing device 204 can comprise any general purpose computing article of manufacture capable of executing computer program code installed by a user (e.g., a personal computer, server, handheld device, etc.). However, it is understood that computing device 204 and control system 200 are only representative of various possible equivalent computing devices that may perform the various process steps of the disclosure. To this extent, in other embodiments, computing device 204 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 203 is only illustrative of various types of computer infrastructures for implementing the disclosure. For example, in one embodiment, computer infrastructure 203 comprises two or more computing devices (e.g., a server cluster) that communicate over any type of wired and/or wireless communications link, such as a network, a shared memory, or the like, to perform the various process steps of the disclosure. When the communications link comprises a network, the network can comprise any combination of one or more types of networks (e.g., the Internet, a wide area network, a local area network, a virtual private network, etc.). Network adapters may also be coupled to the system to enable the data processing system to become coupled to other data processing systems or remote printers or storage devices through intervening private or public networks. Modems, cable modem and Ethernet cards are just a few of the currently available types of network adapters. Regardless, communications between the computing devices may utilize any combination of various types of transmission techniques.

As previously mentioned and discussed further below, control system 200 enables computing infrastructure 203 to transmit operational instructions and real-time operational data to an AR system 206. To this extent, control system 200 is shown including an identifier 230, an instruction generator 232, and a data transmitter 234. Control system 200 may also include other system components 236 capable of operating power plant 100 other than as expressly described herein. Other system components 236 may include any now known or later developed power plant control system 200 components and/or functions for operating power plant 100. Operation of each of these systems is discussed further below, as necessary. It is understood that some of the various systems shown in FIG. 1 can be implemented independently, combined, and/or stored in memory for one or more separate computing devices that are included in computer infrastructure 203. Further, it is understood that some of the systems and/or functionality may not be implemented, or additional systems and/or functionality may be included as part of environment 202.

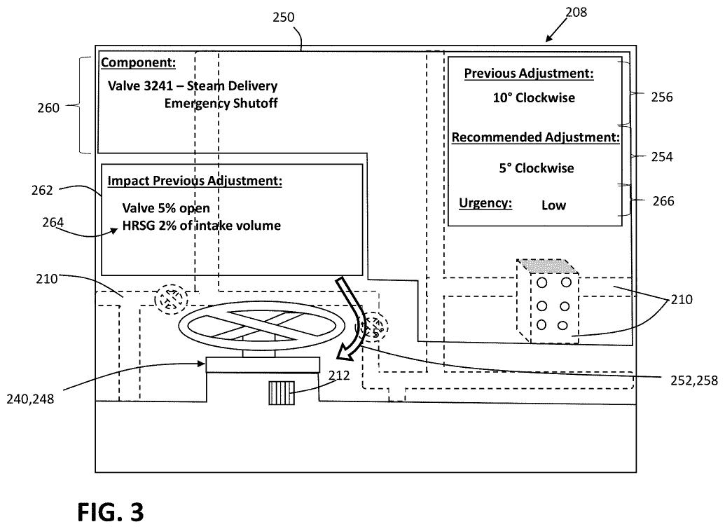

AR system 206 may include any now known or later developed augmented reality, mixed reality, and/or virtual reality system, capable of positioning a computer-generated image or data on a user's view of the real world, thus providing a composite view. FIG. 3 shows one non-limiting example of a display 208 of AR system 206 for purposes of description. AR system 206 may also include any now known or later developed mechanism for providing feedback to control system 200, e.g., hand controllers, voice communications, voice activation, eye tracking, etc.

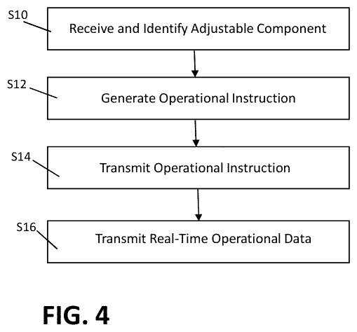

With reference to FIGS. 2-4, a computer-implemented method of controlling operation of at least a portion of power plant 100 will now be described. FIG. 4 shows a flow diagram for describing the computer-implemented method of controlling operation of at least a portion of power plant 100.

In process S10, identifier 230 identifies an adjustable component 240 of a power plant 100 based on an image 242 of at least a portion of adjustable component 240. Image 242 is of a selected adjustable component of a plurality of adjustable components in power plant 100. Control system 200 and identifier 230 may receive image 242 in any manner, e.g., wireless communication. As noted, adjustable component 240 controls at least one operational parameter of the power plant, e.g., a flow of a fluid, a motor setting, etc. For illustration purposes only, adjustable component 240 is shown as a valve in FIG. 2. The operational parameter can be any characteristic of the power plant such as but not limited to: a temperature, pressure, flow rate of a fluid; a setting of a component, e.g., for a valve, percentage open/closed; power output; an electrical phase; a turbine(s) speed; etc. The operational parameter can be any characteristic of the power plant that a change of the adjustable component would alter.

Image 242 can be obtained in any fashion. For example, image 242 can be obtained using an imaging device, e.g., camera, charged couple device, etc., of any appropriate portable electronic device, such as but not limited to a mobile phone, tablet, wearable, an imaging device on AR system 206, etc. Image 242 may include an image of any portion of adjustable component 240 capable of use by control system 200 to identify the adjustable component. For example, where adjustable component 240 includes a valve of a certain size and/or certain surrounding structure, the image may be of a portion of the valve and/or its surroundings (e.g., adjacent components or structure 210 (FIG. 4)) communicating sufficient information for control system 200 to identify adjustable component 240. To this end, control system 200 may include database 244 (e.g., part of memory 212 or storage system 222) that includes a plurality of images of a plurality of adjustable components such that the identifying may include identifying adjustable component 240 from the plurality of images based on image 242 of the at least a portion of adjustable component 240, e.g., through comparison. Identifier 230 may employ any now known or later developed search and identify processing. For example, identifier 230 may use simple image comparison, or any now known or later developed artificial intelligence such as a neural network. Alternatively, where image 242 may include data sufficient to identify adjustable component 240 through a look-up process, identifier 230 may employ a look-up process. In this latter case, adjustable component 240 may include some form of identification 212 (FIG. 4) such as but not limited to: a model number, a serial number, a bar code, a quick response (QR) code, etc. The identification 212 may be used to identify adjustable component 240.

In process S12, instruction generator 232 generates an operational instruction(s) 250 for adjustable component 240 based on image 242, and in process S14, data transmitter 234 may transmit operational instruction 250 to AR system 206 for implementing by a user. Operational instruction 250 is capable of being rendered visually in AR system 206. Operational instruction(s) 250 can be generated in a number of ways. In one embodiment, operational instruction 250 may be generated using artificial intelligence such as a neural network, e.g., to learn the power plant operation over time and upgrade the instructions accordingly. Any variety of inputs may be evaluated in the generating using artificial intelligence such as but not limited to: aspects of image 242 (e.g., quality, size, source device, etc.); current operating conditions of power plant 100 and any number of sections thereof (e.g., load, startup/shutdown, electric phase, etc.); user situation (e.g., location or experience level: trainee, experienced user, emergency responder, manager, worker, etc.); urgency level; desired setting for adjustable component 240 under current situation; and other user input (e.g., natural language input request “is this running ok?”). Data about adjustable component 240 can also be gathered over time as part of instruction generation using artificial intelligence, e.g., current health; wear; degradation due to such things as temperature, pressure, vibration; etc. Instruction generator 232 can use this data to, for example, predict when activities such as calibration, maintenance and/or replacement, may be required. This data can also be part of the operational instruction provided to the user.

In another embodiment, database 244 may include a plurality of operational instructions 250 for a plurality of adjustable components 240 of power plant 100. In this case, instruction generator 232 selects one of the operational instructions for the identified adjustable component 240. Instruction generator 232 may select operational instruction(s) 250 for adjustable component 240 from a plurality of operational instructions based on image 242, and based on an operational status of at least one of the adjustable component 240 and the power plant 100. In the former case, the identification of adjustable component 240 alone may provide sufficient information for control system 200 to generate operational instruction 250. For example, a given operational situation may require turning off of a motor via a switch, the identification of the switch as adjustable component 240 by the user would make control system 200 provide operational instruction 250 via AR system 206 to a user to turn off the motor via the switch. In this case, the operational instruction may be fixed and stored in database 244. In another example, upon identifying adjustable component 240, instruction generator 232 may refer to a data sheet about the adjustable component to determine, for example, its validity or remaining life, and recommend replacement or maintenance, accordingly. In another example, instruction generator 232 may check the current operational parameter(s) that the selected adjustable component 240 controls against a desired status of the operational parameter(s), and generate an appropriate instruction to the adjustable component 240 to bring the current operational parameter(s) to the desired status. That is, instruction generator 232 may select operational instruction(s) 242 based on an operational parameter status of at least one of adjustable component 240 and power plant 100, and the desired status. For example, as shown in FIG. 3, for an adjustable component 240 in the form of a valve 248 that is 5% open and an operational parameter status of some portion of power plant 100 that recommends having the valve more closed, instruction generator 232 may provide operational instruction 250 via AR system 206 that includes a change instruction 252, 254 to a user, e.g., to operate the valve to make it more closed. For example, it may instruct the user to turn the valve 5° clockwise, e.g., see arrow 252 and text 254.

Any level or detail of operational instruction can be used, and any format of display may be provided. Where control system 200 is being employed in a training session, operational instruction 250 may include a training instruction 258 for adjustable component 240, which may be similar to change instruction 252 but may be more informative or educational in its content, e.g., to prevent an undesired adjustment. For example, it may provide suggestions rather than to-do instructions, or it may provide more content about adjustable component 240 and its purpose and/or operation. For an emergency responder, the instruction may guide the user how to make the adjustable component safe, e.g., make it inoperable. In other embodiments, operational instructions 250 may include both a change instruction 252 for adjustable component 240 and a training instruction 258 for the adjustable component.

Operational instruction 250 may also include any variety of other background information such as but not limited to a previous adjustment 256, e.g., 10° clockwise rotation of valve 248. Operational instruction 250 may also include an adjustable component identification confirmation 260 so a user can confirm the operational instruction 250 is for the selected adjustable component they are working on. Operational instruction 250 can also include any additional information a user may require, such as but not limited to: a statement of urgency 266 (e.g., low (shown), medium, high) for the action to be taken; alarm/emergency level (e.g., low, medium, high); audio/visual alerts; etc. In terms of format, operational instruction 250 may take any format including, for example, a video (e.g., with actual instruction like moving arrow, or a training video with more detail about component and impact of its adjustment, or an animated model representation) and/or a pictorial presentation for rendering on AR system 206. Any of the information provided can be updated in real-time, as further described herein.

In process S16, data transmitter 234 transmits real-time operational data to the AR system, real-time operational data 262 including a change 264 to at least one operational parameter based on an adjustment 256 made to adjustable component 240. In the example shown, real-time operational data 262 includes the valve open percentage and its impact on HRSG intake volume. Practically any real-time operational data about an operational parameter of power plant 100 can be provided. The real-time operational data 262 can be obtained in any manner within control system 200, e.g., data storage, measurement, etc. In any event, real-time operational data 262 represents an as-accurate-as-possible representation of the current status of the operational parameter stated. Data transmitter 234 may include any now known or later developed communications system within control system 200 for communicating data to AR system 206. The real-time operational data may assist the user in faster decision-making, improve training of inexperienced users and provide up to the second important information for emergency responders.

The technical effect of power plant control system 100 is the allowance of real-time operational data to be presented to a user of AR system 206 to allow adjustment of an adjustable component 240 based on the actual operation of the power plant. Control system 200 thus can enhance safety of users and property, and allow for faster and error-free decision making. In addition, in-experienced users such as emergency responders that may not be familiar with the component, can operate equipment safely and quickly. The need for access to experts is also greatly reduced.

The flowchart and block diagrams in the drawings illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As discussed herein, various systems and components are described as “generating” data (e.g., control system 200, etc.). It is understood that the corresponding data can be obtained using any solution. For example, the corresponding system/component can generate and/or be used to generate the data, retrieve the data from one or more data stores (e.g., a database), receive the data from another system/component, and/or the like. When the data is not generated by the particular system/component, it is understood that another system/component can be implemented apart from the system/component shown, which generates the data and provides it to the system/component and/or stores the data for access by the system/component.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application and to enable others of ordinary skill in the art to understand the disclosure for various embodiments with various modifications as are suited to the particular use contemplated.

1. A power plant control system, comprising:
a memory; and
a processor coupled to the memory and configured to process events in the processor according to a method that includes:
identifying an adjustable component of a power plant based on an image of at least a portion of the adjustable component, the adjustable component controlling at least one operational parameter of the power plant;
generating an operational instruction for the adjustable component from a database based on the image, the operational instruction capable of being rendered visually in an augmented reality (AR) system;
transmitting the operational instruction to the AR system for implementing by a user; and
transmitting real-time operational data to the AR system, the real-time operational data including a change to the at least one operational parameter based on an adjustment made to the adjustable component.

2. The power plant control system of claim 1, wherein the database includes a plurality of operational instructions for a plurality of adjustable components of the power plant.

3. The power plant control system of claim 1, wherein the database includes a plurality of images of a plurality of adjustable components for use by the component identifier.

4. The power plant control system of claim 1, wherein the identifying includes using a neural network.

5. The power plant control system of claim 1, wherein the generating includes selecting the operational instruction for the adjustable component from a plurality of operational instructions based on the image, and based on an operational status of at least one of the adjustable component and the power plant.

6. The power plant control system of claim 1, wherein the operational instruction includes at least one of a change instruction for the adjustable component and a training instruction for the adjustable component.

7. The power plant control system of claim 1, wherein the operational instruction includes at least one of a video, a pictorial presentation and a model presentation, each for rendering on the AR system.

8. The power plant control system of claim 1, wherein the adjustable component includes at least one of: an electronic control panel, a valve, an electric switch, and an electro-mechanical device.

9. A computer-implemented method of controlling operation of at least a portion of a power plant, the method comprising:
identifying an adjustable component of a power plant based on an image of at least a portion of the adjustable component, the adjustable component controlling at least one operational parameter of the power plant;
generating an operational instruction for the adjustable component from a database based on the image, the operational instruction capable of being rendered visually in an augmented reality (AR) system;
transmitting the operational instruction to the AR system for implementing by a user; and
transmitting real-time operational data to the AR system, the real-time operational data including a change to the at least one operational parameter based on an adjustment made to the adjustable component.

10. The computer-implemented method of claim 9, wherein the database includes a plurality of operational instructions for a plurality of adjustable components of the power plant, and wherein the generating includes selecting one of the operational instructions for the identified adjustable component.

11. The computer-implemented method of claim 9, wherein the database includes a plurality of images of a plurality of adjustable components, and the identifying includes identifying the adjustable component from the plurality of images based on the image of the at least a portion of the adjustable component.

12. The computer-implemented method of claim 9, wherein the identifying includes using a neural network.

13. The computer-implemented method of claim 9, wherein the generating includes selecting the operational instruction for the adjustable component from a plurality of operational instructions based on the image, and based on an operational status of at least one of the adjustable component and the power plant.

14. The computer-implemented method of claim 9, wherein the operational instruction includes at least one of a change instruction for the adjustable component and a training instruction for the adjustable component.

15. The computer-implemented method of claim 9, wherein the operational instruction includes at least one of a video, a pictorial presentation and a model presentation, each for rendering on the AR system.

16. The computer-implemented method of claim 9, wherein the adjustable component includes at least one of: an electronic control panel, a valve, an electric switch, and an electro-mechanical device.

17. A power plant, comprising:
at least one section selected from the group including a gas turbine, a steam turbine, a heat recovery steam generator, a combustor, an electric generator and a compressor;
a plurality of adjustable components, each adjustable component controlling at least one operational parameter of the at least one section; and
a control system configured to control the at least one section, the control system including:
a memory; and
a processor coupled to the memory and configured to process events in the processor according to a method that includes:
identifying a selected adjustable component based on an image of at least a portion of the selected adjustable component, the selected adjustable component controlling at least one operational parameter of the power plant;
generating an operational instruction for the selected adjustable component from a database based on the image, the operational instruction capable of being rendered visually in an augmented reality (AR) system;
transmitting the operational instruction to the AR system for implementing by a user; and
transmitting real-time operational data to the AR system, the real-time operational data including a change to the at least one operational parameter based on an adjustment made to the selected adjustable component.

18. The power plant of claim 17, wherein the database includes a plurality of operational instructions for the plurality of adjustable components of the power plant, and a plurality of images of a plurality of adjustable components for use by the component identifier.

19. The power plant of claim 17, wherein the identifying includes using a neural network.

20. The power plant of claim 17, wherein the generating includes selecting the operational instruction for the adjustable component from a plurality of operational instructions based on the image, and based on an operational status of at least one of the adjustable component and the power plant.
